(19) United States
(12) Patent Application Publication
(10) Pub. No.: US 2016/0192387 A1
(43) Pub. Date: Jun. 30, 2016

(54) BASE STATION APPARATUS FOR GENERATING INFORMATION REMOVING INTER-BEAM INTERFERENCE AND METHOD THEREOF

(71) Applicant: ELECTRONICS AND TELECOMMUNICATIONS RESEARCH INSTITUTE, Daejeon (KR)

(72) Inventor: Jung Sook Bae, Daejeon (KR)

(73) Assignee: ELECTRONICS AND TELECOMMUNICATIONS RESEARCH INSTITUTE, Daejeon (KR)

(21) Appl. No.: 14/983,520

(22) Filed: Dec. 29, 2015

(30) Foreign Application Priority Data
Dec. 30, 2014 (KR) 10-2014-0194069
Oct. 19, 2015 (KR) 10-2015-0145339

(51) Int. Cl. H04W 72/12; H04L 5/00

(52) U.S. Cl. CPC H04W 72/1278; H04L 5/0073

(57) ABSTRACT

Disclosed is a base station apparatus and the base station apparatus includes: a first beam scheduler allocating resources to a plurality of electronic apparatuses corresponding to a first beam and generating resource allocation information including the resource allocation details; a second beam scheduler allocating resources to a plurality of electronic apparatuses corresponding to a second beam and generating resource allocation information including the resource allocation details; and a control scheduler receiving at least some of the resource allocation information generated by the first beam scheduler from the first beam scheduler, receiving at least some among the resource allocation information generated by the second beam scheduler from the second beam scheduler, and transmitting at least some information received from the second beam scheduler to the first beam scheduler, in which the first beam scheduler generates electronic apparatus control information based on at least some among the resource allocation information generated by the first beam scheduler and at least some information received from the control scheduler.

### CROSS-REFERENCE TO RELATED APPLICATIONS

This application claims priority to and the benefit of Korean Patent Application No. 10-2014-0194069 filed in the Korean Intellectual Property Office on Dec. 30, 2014 and No. 10-2015-0145339 filed in the Korean Intellectual Property Office on Oct. 19, 2015 and the entire contents of which are incorporated herein by reference.

### TECHNICAL FIELD

The present invention relates to a base station apparatus for generating scheduling information for removing inter-beam interference in a multi-beam based mobile communication system and a method thereof.

### BACKGROUND ART

Mobile communication traffic has rapidly increased every year with extension of IoT, rapid propagation of a smart device, and appearance of a realistic UHD service and mobile communication traffic in 2020 is predicted to be 1000 times more than the current mobile communication traffic. For transmitting and processing the mobile communication traffic which is congested as described above, in a 5^{th} generation mobile communication system, the need of a new frequency band providing a wideband comes to the forefront. To this end, using a millimeter wave band of 30 to 300 GHz is considered. The millimeter wave band is wider and it is easier to allocate consecutive radio resources than a band of 3 GHz or less used in a mobile communication network to increase a capacity of a communication system. However, since the millimeter wave band is large in linearity and propagation loss, a beamforming technology based on multiple antennas is applied to a millimeter wave based mobile communication system in order to overcome large linearity and propagation loss.

The beamforming technology can be classified into fixed and adaptive beamforming technologies and the fixed beamforming technology is preferentially considered due to comparatively simple hardware complexity and small operating overhead. Generated beams constitute cells of a small area reusing a frequency resource and in a fixed beamforming scheme, since overlapped beams are generated in order to prevent a coverage hole, an influence of inter-beam interference on a terminal in a beam overlapping area increases.

Such an interference problem can be solved by a method using a transmission method for reducing the inter-beam interference in a base station. For example, adjacent beams divide and use resources in a beam boundary area like fractional frequency reuse (FFR) or the adjacent beams perform coordination transmission through a coordinated multi-point transmission and reception (COMP) scheme, and the like to avoid interference. In this case, a periodic channel information feed-back for a primary beam to which the terminal belongs and interference beams is required and when feed-back overhead and inaccuracy of feed-back information are considered, there are limitations.

### SUMMARY OF THE INVENTION

Various exemplary embodiments of the present invention have been made in an effort to provide a base station apparatus generating scheduling information removing inter-beam interference and a method thereof.

Particularly, various exemplary embodiments of the present invention have been made in an effort to provide a method transmitting the generated scheduling information to an electronic apparatus which becomes a target of interference deletion and allowing the electronic apparatus to delete interference by using the scheduling information and a base station apparatus thereof.

The objects of the present invention are not limited to the aforementioned objects, and other objects, which are not mentioned above, will be apparent to a person having ordinary skill in the art from the following description.

An exemplary embodiment of the present invention provides a base station apparatus including: a first beam scheduler allocating resources to a plurality of electronic apparatuses corresponding to a first beam and generating resource allocation information including the resource allocation details; a second beam scheduler allocating resources to a plurality of electronic apparatuses corresponding to a second beam and generating resource allocation information including the resource allocation details; and a control scheduler receiving at least some of the resource allocation information generated by the first beam scheduler from the first beam scheduler, receiving at least some among the resource allocation information generated by the second beam scheduler from the second beam scheduler, and transmitting at least some information received from the second beam scheduler to the first beam scheduler, wherein the first beam scheduler generates electronic apparatus control information based on at least some among the resource allocation information generated by the first beam scheduler and at least some information received from the control scheduler.

The first beam scheduler may transmit the generated electronic apparatus control information to a target electronic apparatus.

The transmitted electronic apparatus control information may allow the target electronic apparatus to delete interference from the second beam.

The target electronic apparatus may be positioned in the first beam, and positioned in the second beam or positioned within a predetermined distance from the second beam.

The second beam may include a plurality of beams, and the second beam scheduler may include a plurality of beam schedulers corresponding to the plurality of beams, respectively.

The resource allocation information may include a location and a resource quantity of the allocated resource.

At least some resource allocation information received from the first beam scheduler may include the resource allocation information for the target electronic apparatus, and at least some resource allocation information received from the second beam scheduler may include resource allocation information for another electronic apparatus corresponding to the target electronic apparatus.

The resource allocation information for another electronic apparatus may include identification information and interference resource information for another electronic apparatus.

Another exemplary embodiment of the present invention provides a method performed in a base station apparatus, including: an operation of allocating, by a first beam scheduler, resources to a plurality of electronic apparatuses corresponding to a first beam and generating resource allocation information including the resource allocation details; an operation of allocating, by a second beam scheduler, resources to a plurality of electronic apparatuses corresponding to a second beam and generating resource allocation information including the resource allocation details; an operation of receiving, by a control scheduler, at least some of the resource allocation information generated by the first beam scheduler from the first beam scheduler; an operation of receiving, by the control scheduler, at least some among the resource allocation information generated by the second beam scheduler from the second beam scheduler; an operation of transmitting, by the control scheduler, at least some information received from the second beam scheduler to the first beam scheduler; and an operation of generating, by the first beam scheduler, electronic apparatus control information based on at least some among the resource allocation information generated by the first beam scheduler and at least some information received from the control scheduler.

The method may further include an operation of transmitting, by the first beam scheduler, the generated electronic apparatus control information to a target electronic apparatus.

In order to solve the problems in the related art, according to various exemplary embodiments of the present invention, in a fixed beamforming scheme multi-beam based mobile communication system, inter-beam interference can be deleted in a target electronic apparatus by base station support information without a feed-back procedure of complicated channel information.

In detail, according to various exemplary embodiments of the present invention, in controlling inter-beam interference in a multi-beam based mobile communication system based on beams constituting cells of a small area reusing a frequency resource, an electronic apparatus as a receiver accurately reproduces an interference signal by using interference deletion support information of a base station apparatus to delete interference without interference avoidance of the base station apparatus based on a complicated and inaccurate feed-back procedure of the electronic apparatus. Therefore, various exemplary embodiments of the present invention can cause improvement of receiving quality and contribute to improvement of overall system yield.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 is a diagram illustrating a base station apparatus and a beam generated by the base station apparatus according to various exemplary embodiments of the present invention.

FIG. 2 is a diagram illustrating a main beam corresponding to the location of a target electronic apparatus and an interference beam which can influence the target electronic apparatus according to various exemplary embodiments of the present invention.

FIG. 3 is a block diagram illustrating a configuration of a base station apparatus according to various exemplary embodiments of the present invention.

FIG. 4 is a flowchart illustrating a method of generating electronic apparatus control information in a base station apparatus according to various exemplary embodiments of the present invention.

FIG. 5 is a flowchart illustrating a method of generating electronic apparatus control information in a base station apparatus according to various exemplary embodiments of the present invention.

FIG. 6 is a configuration diagram of a base station apparatus according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the present invention will be described in detail with reference to the accompanying drawings. When reference numerals refer to components of each drawing, it is noted that although the same components are illustrated in different drawings, the same components are referred to by the same reference numerals as possible. Further, a detailed description of an already known function and/or configuration will be skipped. In contents disclosed hereinbelow, a part required for understanding an operation according to various exemplary embodiments will be described in priority and a description of elements which may obscure the spirit of the present invention will be skipped. Further, some components of the drawings may be enlarged, omitted, or schematically illustrated. An actual size is not fully reflected on the size of each component and therefore, contents disclosed herein are not limited by relative sizes or intervals of the components drawn in the respective drawings.

According to various exemplary embodiments of the present invention, the inter-beam interference mentioned as the problem may be solved by transmitting information generated in a base station apparatus to an electronic apparatus and by receiving and using the information by the electronic apparatus. The method has an advantage in that the base station apparatus provides resource allocation information of the interference beam which may influence the corresponding electronic apparatus to the electronic apparatus to delete the interference in the electronic apparatus as a receiver without feed-back overhead.

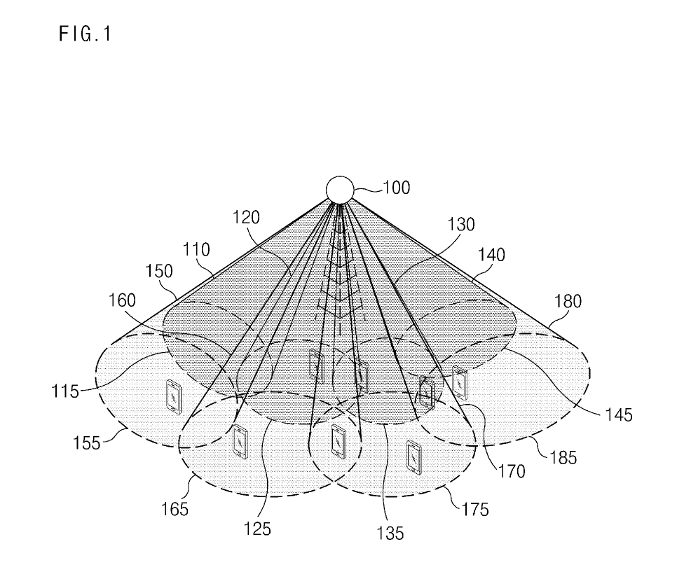

FIG. 1 is a diagram illustrating a base station apparatus and a beam generated by the base station apparatus according to various exemplary embodiments of the present invention.

Referring to FIG. 1, a base station apparatus 100, beams 110 to 180 provided from the base station apparatus 100, a plurality of beam areas 115 to 185 for the beams 110 to 180, and a plurality of electronic apparatuses positioned throughout the plurality of beam areas 115 to 185 are illustrated.

The plurality of beam areas 115 to 185 may be generated by fixed beam directions and beam sizes of 3D beams 110 to 180 decided by the base station apparatus 100. Referring to the beam areas 115 to 185, at least some of the beam areas 115 to 185 may overlap with each other in order to prevent a coverage hole (an area not included in the beam areas 115 to 185).

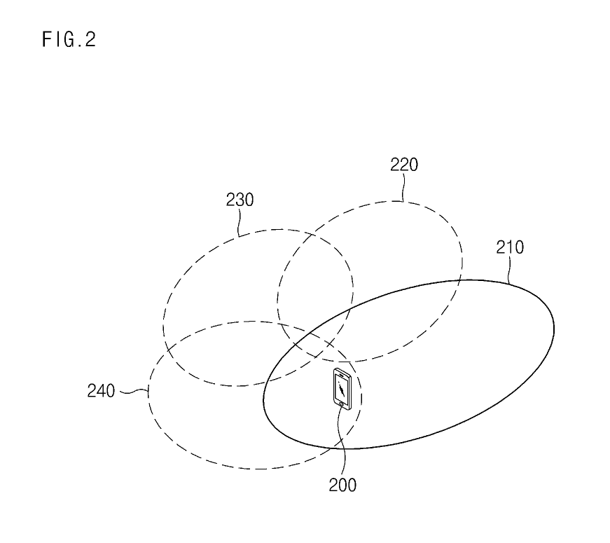

FIG. 2 is a diagram illustrating a main beam corresponding to the location of a target electronic apparatus and an interference beam which can influence the target electronic apparatus according to various exemplary embodiments of the present invention.

Referring to FIG. 2, a target electronic apparatus 200, a main beam area 210, and interference beam areas 220 to 240 are illustrated. The target electronic apparatus 200 may be included in the main beam area 210 and the target electronic apparatus 200 may be allocated with a scheduling resource by a beam scheduler (not illustrated) corresponding to the main beam area 210.

However, the target electronic apparatus 200 may be influenced by beam schedulers corresponding to interference beam areas 220 to 240, respectively, in addition to the main beam area 210. For example, with respect to a scheduling resource allocated by a beam scheduler corresponding to the main beam area 210, the beam schedulers (not illustrated) corresponding to the interference beam areas 220 to 240, respectively, may allocate the scheduling resource to another electronic apparatus (not illustrated) included in the interference beam areas 220 to 240. In such a case, the target electronic apparatus 200 is influenced by the interference beam areas 220 to 240, and as a result, communication yield, and the like may deteriorate.

According to various exemplary embodiments of the present invention, the beam scheduler corresponding to the main beam area 210 and the beam schedulers corresponding to the interference beam areas 220 to 240, respectively as different components, may be included in the base station apparatus 100.

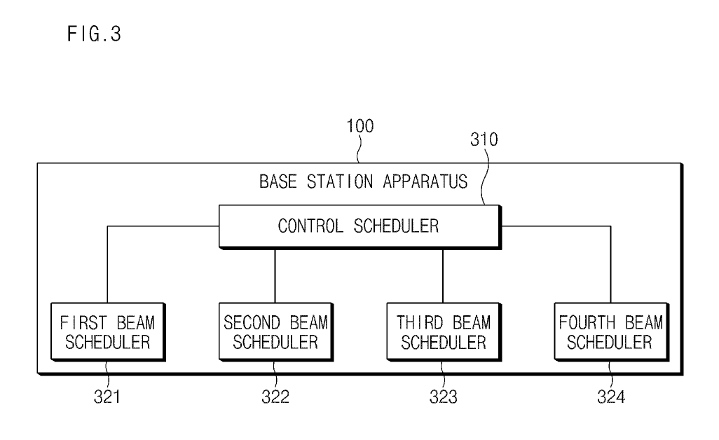

FIG. 3 is a block diagram illustrating a configuration of a base station apparatus according to various exemplary embodiments of the present invention. Referring to FIG. 3, the base station apparatus 100 may include a control scheduler 310 and a plurality of beam schedulers 321 to 324. It is illustrated that 4 beam schedulers are provided in FIG. 3, but the base station apparatus 100 may include more beam schedulers. However, in FIG. 3, for easy description, it is illustrated that only the beam scheduler which may influence the target electronic apparatus 200 illustrated in FIG. 2 is included in the base station apparatus 100. The beam schedulers 321 to 324 may correspond to the beam areas 210 to 240 illustrated in FIG. 2. For example, the beam scheduler 321 may be the beam scheduler corresponding to the main beam area 210 and the beam schedulers 322 to 324 may be the beam scheduler corresponding to the interference beam area 220.

The constitution of the base station electronic apparatus 100 illustrated in FIG. 3 is just one implementation example of the present invention and may be variously modified. For example, although not illustrated in FIG. 3, the base station apparatus 100 may further include the memory. Furthermore, the base station apparatus 100 may further include a user interface for receiving any command or information from a user. In this case, the user interface may be generally an input device such as a keyboard, a mouse, or the like, but a graphical user interface (GUI) displayed on a screen of the base station apparatus 100.

The control scheduler 310 may configure the main beam for the target electronic apparatus 200 and configure an interference beam aggregate which may cause the interference, based on location or channel information of the electronic apparatuses registered in the base station apparatus 100. Hereinafter, the second beam scheduler 322 to the fourth beam scheduler 324 will be referred to as the interference beam schedulers 322 to 324.

The control scheduler 310 may request resource allocation information for the target electronic apparatus 200 to the first beam scheduler 321. As a response thereto, the control scheduler 310 may receive the resource allocation information for the target electronic apparatus 200 from the first beam scheduler 321.

The control scheduler 310 may request whether resource allocation to another electronic apparatus is performed in the resource area allocated to the target electronic apparatus 200 to the interference beam schedulers 322 to 324 and if so, the control scheduler 310 may further request the resource allocation information to the another electronic apparatus. The request may include the resource allocation information to the target electronic apparatus 200, which is received by the control scheduler 310.

The control scheduler 310 may receive identification information and interference resource allocation information lists for the another electronic apparatus from the interference beam schedulers 322 to 324. The interference resource allocation information may include a range of the interference area and a modulation and coding rate scheme (MCS).

The control scheduler 310 may transmit to the first beam scheduler 321 the identification information and the interference resource allocation information for the another electronic apparatus, which are received from the interference beam schedulers 322 to 324.

The respective beam schedulers 321 to 324 may perform scheduling for the electronic apparatuses positioned in the respective beam areas. Further, when the scheduling is completed, the respective beam schedulers 321 to 324 may announce the scheduling completion to the control scheduler 310.

The respective beam schedulers 321 to 324 may allocate resources for user and control plane packets to the electronic apparatuses positioned in the respective beam areas. The resource allocation may be performed based on a QoS requirement associated with a radio bearer, a channel quality for the electronic apparatus, a buffer state, an interference situation, limitation for a specific resource, and preference for the specific resource.

The first beam scheduler 321 may receive a request for the resource allocation information to the target electronic apparatus 200 from the control scheduler 310. As a response thereto, the beam scheduler 321 may transmit to the control scheduler 310 the resource allocation information to the target electronic apparatus 200. The resource allocation information may include information on a location and a resource amount of an allocated resource.

The respective interference beam schedulers 322 to 324 may receive a request for the resource allocation information to the another electronic apparatus from the control scheduler 310. As a response thereto, the respective interference beam schedulers 322 to 324 may examine whether the resource allocated to the target electronic apparatus 200 is allocated to another electronic apparatus. According to various exemplary embodiments of the present invention, another electronic apparatus for the second beam scheduler 322, another electronic apparatus for the third beam schedulers 323, and another electronic apparatus for the fourth beam scheduler 324 may be at least the same as or different from each other.

As the examination result, when the resource allocated to the target electronic apparatus 200 is allocated to another electronic apparatus, the respective interference beam schedulers 322 to 324 may transmit to the control scheduler 310 the interference resource allocation information for other respective electronic apparatuses.

The first beam scheduler 321 may receive the interference resource allocation information from the control schedule 320. The first beam scheduler 321 may generate electronic apparatus control information based on the received interference resource allocation information and the resource allocation information for the target electronic device 200. Further, the electronic apparatus control information may be downlink control information. Further, the first beam scheduler 321 transmits the generated electronic apparatus control information to the target electronic apparatus 200.

The electronic apparatus control information may include information to allow the target electronic apparatus 200 to delete the interference. For example, the target electronic apparatus 200 may delete the interference by a method that reproduces an interference signal and subtracts the reproduced interference signal from a received signal based on the received electronic apparatus control information.

According to various exemplary embodiments of the present invention, the electronic apparatus control information may be generated by the control scheduler 310.

According to various exemplary embodiments of the present invention, the control scheduler 310 and/or the beam schedulers 321 to 324 may be implemented as, for example, a system on chip (SoC) and include one or more among a central processing unit (CPU), a graphic processing unit (GPU), an image signal processor, an application processor (AP), and a communication processor (CP). The control scheduler 310 and/or the beam schedulers 321 to 324 may load and process a command or data received from at least one among other components from a memory (not illustrated) and store various data in the memory.

The memory may store data, for example, instructions for operations performed by the control scheduler 310 and/or the beam schedulers 321 to 324. In this case, the data stored in the memory may include data input and output among the respective components in the base station apparatus 100 and include data input and output among the base station apparatus 100 and the components outside the base station apparatus 100.

The memory may include an embedded memory or an exterior memory. The embedded memory may include at least one of, for example, a volatile memory (e.g., dynamic RAM (DRAM), a static RAM (SRAM), or a synchronous dynamic RAM (SDRAM)), a non-volatile memory (e.g., a one time programmable ROM (OTPROM), a programmable ROM (PROM), an erasable and programmable ROM (EPROM), an electrically erasable and programmable ROM (EEPROM), a mask ROM, a flash ROM, a flash memory (e.g., NAND flash), or a NOR flash), a hard disk drive (HDD), and a solid state drive (SSD).

The exterior memory may further include, for example, a flash drive, for example, compact flash (CF), secure digital (SD), a Micro-SD, a Mini-SD, extreme digital (xD), MultiMediaCard (MMC), or a memory stick. The exterior memory may be functionally and/or physically connected with the base station apparatus 100 through various interfaces.

Those skilled in the art will sufficiently understand that each of the control scheduler 310, the beam schedulers 321 to 324, and the memory may be separately implemented in the electronic device 10 or one or more components among them may be integrated and implemented.

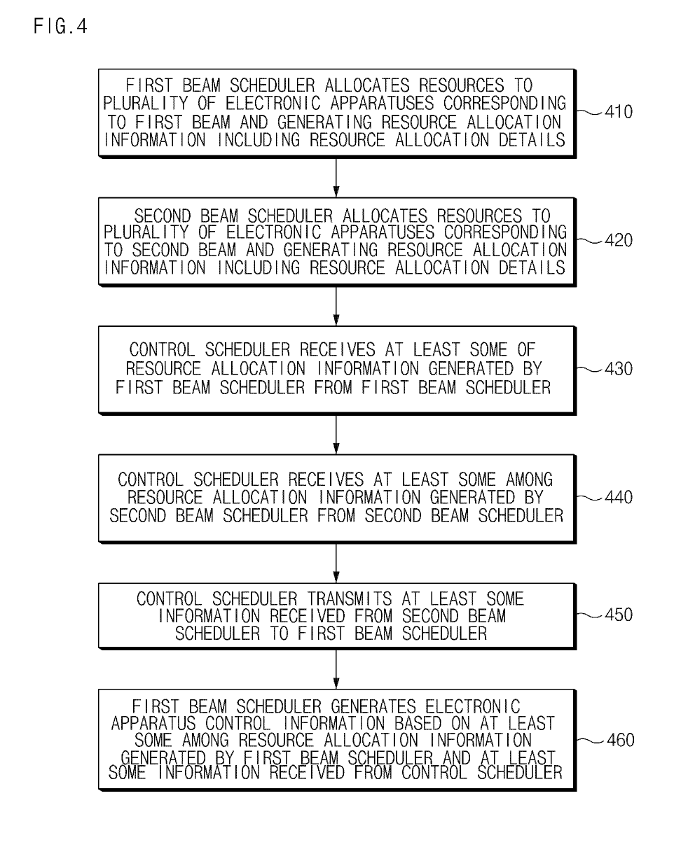

FIG. 4 is a flowchart illustrating a method of generating electronic apparatus control information in a base station apparatus according to various exemplary embodiments of the present invention. The method of generating the electronic apparatus control information in the base station apparatus illustrated in FIG. 4 may be performed by the base station apparatus 100 described through FIGS. 1 to 3 given above. Therefore, in spite of contents which are omitted below, the contents regarding the method in which the base station apparatus 100 generates the electronic apparatus control information, which is described through FIGS. 1 to 3 may be applied even to FIG. 4.

In operation 410, the first beam scheduler 321 may allocate resources to a plurality of electronic apparatuses corresponding to a first beam and generate resource allocation information including the resource allocation details.

In operation 420, the interference beam schedulers 322 to 324 may allocate resources to a plurality of electronic apparatuses corresponding to an interference beam and generate resource allocation information including the resource allocation details.

In operation 430, the control scheduler 310 may receive at least some among the resource allocation information generated in operation 410 from the first beam scheduler 321.

In operation 440, the control scheduler 310 may receive at least some of the resource allocation information generated in operation 420 from the interference beam schedulers 322 to 324.

In operation 450, the control scheduler 310 may transmit to the first beam scheduler 321 at least some information received in operation 440.

In operation 460, the first beam scheduler 321 may generate the electronic apparatus control information based on at least some among the resource allocation information generated in operation 410 and at least some of the information transmitted in operation 450.

Operations 410 to 460 do not limit respective operation orders and according to various exemplary embodiments of the present invention, a plurality of operations may be simultaneously performed and any one operation may be performed while being divided into multiple operations.

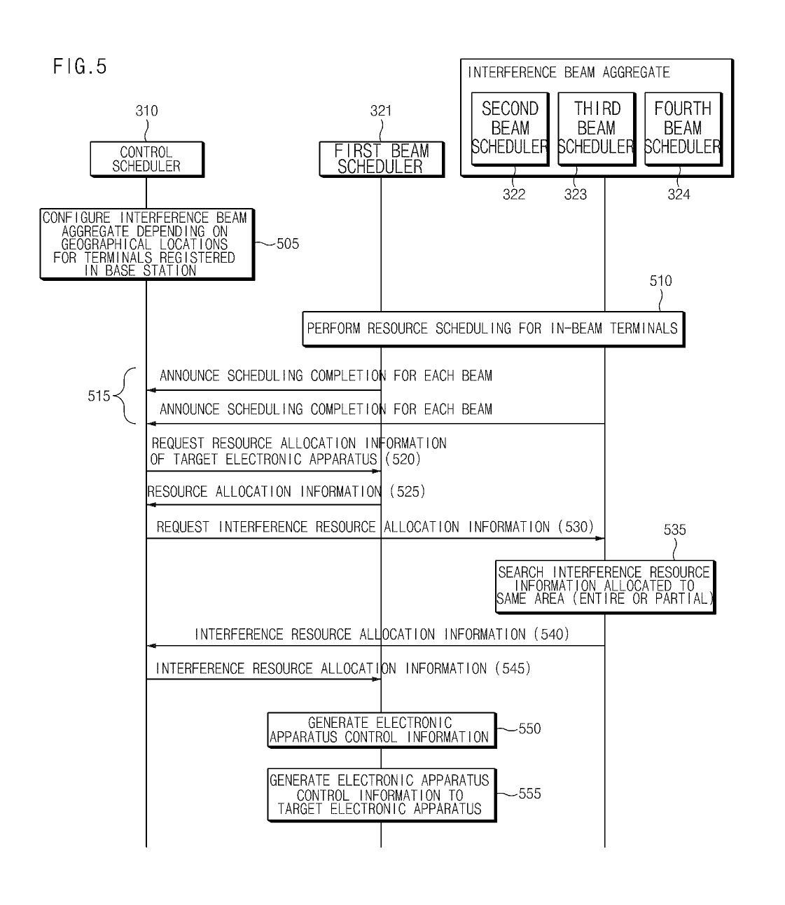

FIG. 5 is a flowchart illustrating a method of generating electronic apparatus control information in a base station apparatus according to various exemplary embodiments of the present invention. The method of generating the electronic apparatus control information in the base station apparatus illustrated in FIG. 5 may be performed by the base station apparatus 100 described through FIGS. 1 to 4 given above. Therefore, in spite of contents which are omitted below, the contents regarding the method in which the base station apparatus 100 generates the electronic apparatus control information, which is described through FIGS. 1 to 4 may be applied even to FIG. 5.

In operation 505, the control scheduler 310 may determine the interference beam aggregate for the target electronic apparatus 200 based on information on the plurality of electronic apparatuses registered in the base station apparatus 100. In various exemplary embodiments of the present invention, the control scheduler 310 may determine the beams corresponding to the second beam scheduler 322 to the fourth beam scheduler 324 as the interference beam aggregate.

In operation 510, the beam schedulers 321 to 324 may perform resource scheduling for the electronic apparatuses included in the beams corresponding thereto, respectively.

In operation 515, the beam schedulers 321 to 324 may announce to the control scheduler 310 completion of the resource scheduling performed in operation 510.

In operation 520, the control scheduler 310 may request resource allocation information for the target electronic apparatus 200 to the first beam scheduler 321.

In operation 525, the first beam scheduler 321 may transmit the resource allocation information to the control scheduler 310.

In operation 530, the control scheduler 310 may request interference resource allocation information for another electronic apparatus to the interference beam schedulers 322 to 324. The interference resource allocation information may be resource allocation information for the case in which at least some among resources allocated to the target electronic apparatus 200 are allocated to the other electronic apparatus.

In operation 535, the interference beam schedulers 322 to 324 may search the interference resource allocation information.

In operation 540, the interference beam schedulers 322 to 324 may transmit to the control scheduler 310 the interference resource allocation information searched in operation 535.

In operation 545, the control scheduler 310 may transmit the interference resource allocation information for the target electronic apparatus 200 to the first beam scheduler 321.

In operation 550, the first beam scheduler 321 may generate the electronic apparatus control information based on the resource allocation information as a result of scheduling performed with respect to the target electronic apparatus 200 in operation 510 and the interference resource allocation information for the target electronic apparatus 200, which is received in operation 545.

In operation 555, the first beam scheduler 321 may transmit the electronic apparatus control information generated in operation 550 to the target electronic apparatus 200.

Operations 505 to 555 do not limit respective operation orders and according to various exemplary embodiments of the present invention, a plurality of operations may be simultaneously performed and any one operation may be performed while being divided into multiple operations.

Operations 510 to 555 may be performed every scheduling unit time and operations 520 to 550 may be performed with respect to all electronic apparatuses registered in the base station apparatus 100. For example, the reason is that a beam area corresponding to the first beam scheduler 321 may be an interference beam area for another electronic apparatus.

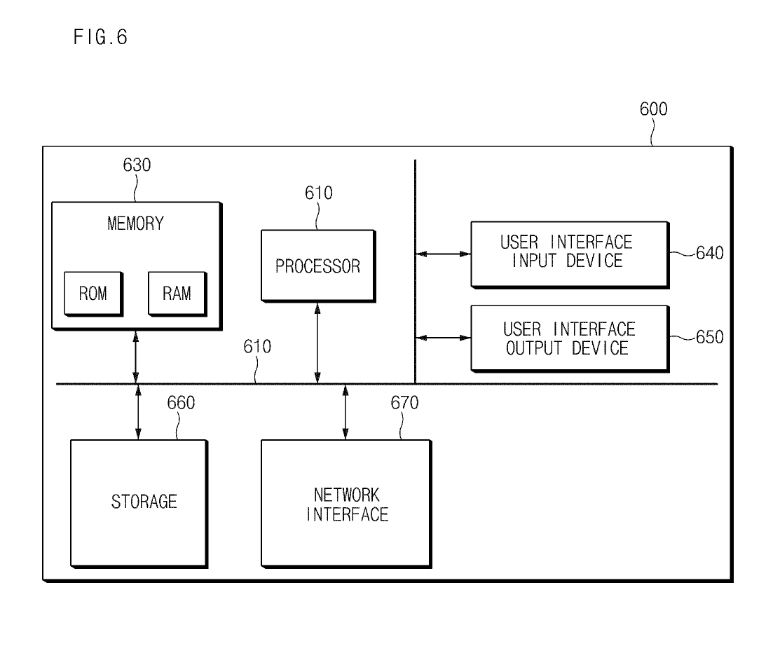

FIG. 6 is a configuration diagram of a base station apparatus according to another exemplary embodiment of the present invention.

Referring to FIG. 6, a computing system 600 may include at least one processor 610, a memory 620, a user interface input device 640, a user interface output device 650, a storage 660, and a network interface 670 connected through a bus 620.

The processor 610 may be a central processing unit (CPU) or a semiconductor device that executes processing of commands stored in the memory 630 and/or the storage 660. The memory 630 and the storage 660 may include various types of volatile or non-volatile storage media. For example, the memory 630 may include a read only memory (ROM) and a random access memory (RAM).

Therefore, steps of a method or an algorithm described in association with the exemplary embodiments disclosed in the specification may be directly implemented by hardware and software modules executed by the processor 610, or a combination thereof. The software module may reside in storage media (that is, the memory 630 and/or the storage 660) such as a RAM memory, a flash memory, a ROM memory, an EPROM memory, an EEPROM memory, a register, a hard disk, a removable disk, and a CD-ROM. The exemplary storage medium is coupled to the processor 610 and the processor 610 may read information from the storage medium and write the information in the storage medium. As another method, the storage medium may be integrated with the processor 610. The processor and the storage medium may reside in an application specific integrated circuit (ASIC). The ASIC may reside in a user terminal. As yet another method, the processor and the storage medium may reside in the user terminal as individual components.

The specified matters and limited embodiments and drawings such as specific components in the present invention have been disclosed for illustrative purposes, but are not limited thereto, and those skilled in the art will appreciate that various modifications and changes can be made in the art to which the present invention belongs, within the scope without departing from an essential characteristic of the present invention. The spirit of the present invention should not be defined only by the described exemplary embodiments, and it should be appreciated that and claims to be described below and all technical spirits which evenly or equivalently modified are included in the claims of the present invention.

What is claimed is:

1. A base station apparatus comprising:
a first beam scheduler allocating resources to a plurality of electronic apparatuses corresponding to a first beam and generating resource allocation information including the resource allocation details;
a second beam scheduler allocating resources to a plurality of electronic apparatuses corresponding to a second beam and generating resource allocation information including the resource allocation details; and
a control scheduler receiving at least some of the resource allocation information generated by the first beam scheduler from the first beam scheduler, receiving at least some among the resource allocation information generated by the second beam scheduler from the second beam scheduler, and transmitting at least some information received from the second beam scheduler to the first beam scheduler,
wherein the first beam scheduler generates electronic apparatus control information based on at least some among the resource allocation information generated by the first beam scheduler and at least some information received from the control scheduler.

2. The base station apparatus of claim 1, wherein the first beam scheduler transmits the generated electronic apparatus control information to a target electronic apparatus.

3. The base station apparatus of claim 2, wherein the transmitted electronic apparatus control information allows the target electronic apparatus to delete interference from the second beam.

4. The base station apparatus of claim 2, wherein the target electronic apparatus is positioned in the first beam, and positioned in the second beam or positioned within a predetermined distance from the second beam.

5. The base station apparatus of claim 1, wherein the second beam includes a plurality of beams, and
the second beam scheduler includes a plurality of beam schedulers corresponding to the plurality of beams, respectively.

6. The base station apparatus of claim 1, wherein the resource allocation information includes a location and a resource quantity of the allocated resource.

7. The base station apparatus of claim 2, wherein at least some resource allocation information received from the first beam scheduler includes the resource allocation information for the target electronic apparatus, and
at least some resource allocation information received from the second beam scheduler includes resource allocation information for another electronic apparatus corresponding to the target electronic apparatus.

8. The base station apparatus of claim 7, wherein the resource allocation information for another electronic apparatus includes identification information and interference resource information for another electronic apparatus.

9. A method performed in a base station apparatus, the method comprising:
an operation of allocating, by a first beam scheduler, resources to a plurality of electronic apparatuses corresponding to a first beam and generating resource allocation information including the resource allocation details;
an operation of allocating, by a second beam scheduler, resources to a plurality of electronic apparatuses corresponding to a second beam and generating resource allocation information including the resource allocation details;
an operation of receiving, by a control scheduler, at least some of the resource allocation information generated by the first beam scheduler from the first beam scheduler;
an operation of receiving, by the control scheduler, at least some among the resource allocation information generated by the second beam scheduler from the second beam scheduler;
an operation of transmitting, by the control scheduler, at least some information received from the second beam scheduler to the first beam scheduler; and
an operation of generating, by the first beam scheduler, electronic apparatus control information based on at least some among the resource allocation information generated by the first beam scheduler and at least some information received from the control scheduler.

10. The method of claim 9, further comprising:
an operation of transmitting, by the first beam scheduler, the generated electronic apparatus control information to a target electronic apparatus.
